(19) United States
(12) Patent Application Publication
(10) Pub. No.: US 2004/0225578 A1
(43) Pub. Date: Nov. 11, 2004

(54) Consumer shopping tool to augment retail sales

(76) Inventors: Jonathan M. Hager, Roanoke, VA (US); Kenneth W. Kayser, Roanoke, VA (US); Kenneth M. Kiplinger, Tipp City, OH (US); Timothy B. Honeck, Brentwood, TN (US)

Correspondence Address: THOMPSON HINE LLP, 2000 COURTHOUSE PLAZA N.E., 10 WEST SECOND STREET, DAYTON, OH, 45402-1758, US

(21) Appl. No.: 10/867,238

(22) Filed: Jun. 14, 2004

Related U.S. Application Data
(62) Division of application No. 09/771,362, filed on Jan. 26, 2001.
(60) Provisional application No. 60/178,365, filed on Jan. 27, 2000.

(51) Int. Cl. G06F 17/60; G06K 15/00; G06G 1/12

(52) U.S. Cl. 705/26; 705/21

(57) ABSTRACT

Linking the consumer to retailer pricing and database information creates a full-feature shopping tool. The Internet is used as a vehicle to enable customer access to portions of this information from any remotely located computer. Using software resident on the remote computer, the consumer may interact with the database through a Web service to check on product availability, identify item discounts, view promotional specials, access product information, price comparison shop, and plan their shopping visit to the store. The patented Display Edge Technology, Ltd. (DET) Electronic Shelf Label (ESL) System facilitates the Web service with access to the store database. In addition, the ESL system allows for the highlighting of special pricing or tier pricing utilizing display screen annunciators or light emitting devices.

This application claims the benefit of provisional application Ser. No. 60/178,365 filed Jan. 27, 2000

### FIELD OF THE INVENTION

The present invention relates generally to an Internet based shopping tool useful in the grocery retail, health and beauty aid retail, and other types of stores in the retail industry, and more particularly to an Internet based shopping tool configured for interaction with electronic product information display systems of such retail sites. Benefits to the retailer through enhanced customer loyalty, opportunity to compete on product and service offerings through a new media, and increased customer traffic as a result of shopping efficiency and dynamic promotions may be facilitated.

### SUMMARY OF THE INVENTION

In one aspect, a tool that enhances their retail shopping experience through household inventory management, planned shopping visits, and timely information is provided for consumers.

In another aspect, the retailer and the product manufacturer are provided with an additional media for advertising and promotions. This medium assures that the information reaches the consumer prior to their shopping visit.

In still another aspect, an electronic infrastructure that delivers actual store pricing and inventory information from an in-store ESL system to an internet shopping tool is provided.

In still another aspect, the retailer's promotional and customer loyalty programs are facilitated, enabling improved differentiation and execution of multi-tier product pricing programs.

In yet another aspect, a means for comparison shopping from a remote location is provided. The Display Edge Technology Electronic Shelf Label (ESL) system as described in U.S. Pat. Nos. 5,537,126, 5,736,967 and 6,089,453, the specifications of which are hereby incorporated by reference, has complete and immediate knowledge of product pricing for each store in which it is installed. Other known ESL systems have similar capabilities. Under release by the retailer, these ESL systems can supply accurate pricing information for a list of desired products price comparison. In addition, stores that do not have ESL equipment may elect to participate by supplying product information directly.

In a further aspect, a software tool allows a list of desired products to be entered and maintained. One embodiment includes a web site for the consumer to transfer information and facilitate operation of the tools. The web site will also be the advertising medium where the retailer and manufacturer can obtain exposure. In addition, a partial or complete ESL system can facilitate the collection of the necessary data used in the shopping features. In addition, retail store management and administration personnel can use a web based administration tool to enter data into the system.

In another aspect, a method of providing consumer access to store product and pricing data involves (a) providing a web site system from which a consumer can access product and pricing information for a plurality of stores; (b) providing a communications link for communicating store product and pricing information from stores to the web site system; (c) monitoring a time since a last product and pricing information update from a given store; and (d) preventing the consumer from accessing the product and pricing information for the given store if the time exceeds a set threshold.

In yet a further aspect, a computerized method for facilitating consumer price comparison involves (a) providing a web site where a given user can enter a list of desired products and enter information for desired stores; (b) for each desired store: (i) checking a product pricing database for a price associated with each desired product; (ii) generating a store total price amount for all items in the list of desired products; and (c) providing the given user access to the store total price amount for each desired store for comparing total cost of shopping at the desired stores.

### BRIEF DESCRIPTION OF THE DRAWINGS

FIG. 1 is a schematic block diagram of one embodiment illustrating the paths used to exchange the information with the tool and provide the desired features;

FIG. 2 is a schematic block diagram of a second embodiment with a direct link to an ESL system; and

FIG. 3 illustrates an electronic display tag including a web directing label thereon.

FIG. 4 is an overall process flow diagram of one embodiment of the system.

FIG. 5 is a flow diagram of one embodiment of the administrator process used by a retailer.

FIG. 6 is a flow diagram of one embodiment of the consumer process used by a consumer to modify a profile, select products, or organize future products for purchase.

### DETAILED DESCRIPTION OF THE DRAWINGS

Referring to FIG. 1, one embodiment of an Internet web services system 100 that is linked to multiple stores through a web based administration tool 102 (computer) is shown. The retailer uses the tool 102 to update product information on a regular basis. The updated product information may be delivered to the Internet web services system 100 for storage on a store-specific database 108 of the system. Alternatively, the data may be maintained on a database at the store site for automatic access by the Internet web services system 100 when needed. Consumers utilize their personal computer/web browser unit 104, or other Internet access device, to access the Internet web services system 100 via the system web server 106.

The second embodiment (FIG. 2) includes an Internet web services system 200 that is linked directly to the product information display system 202 (hereafter “ESL system”) that is located within each retail store. This link allows for accurate and timely product information to be presented to the consumer because the information stored on the Internet web services system database 204 can be updated on a regular basis. Another advantage to this embodiment is that web server and ESL systems 202 can be interlocked to prevent inaccurate or outdated information from being presented to the consumer 206. The interlock may be provided by associating a time stamp with each store's product list/database, where the time stamp is updated each time communication between the store's ESL system and the web services system takes place. The web services system includes software for monitoring the time stamp and preventing the display or dissemination of data from the store's product list/database to consumer's if a time period since that store's product list/database was updated exceeds an established, acceptable time period. The established, acceptable time period may be the same for all stores or may be specific to each store according to the store's preference.

The web based administration tool 208 may still be provided at each store site for updating information not normally included on the ESL system 202, such as daily information regarding items in the hot foods case, the fresh seafood of the day, or daily specials.

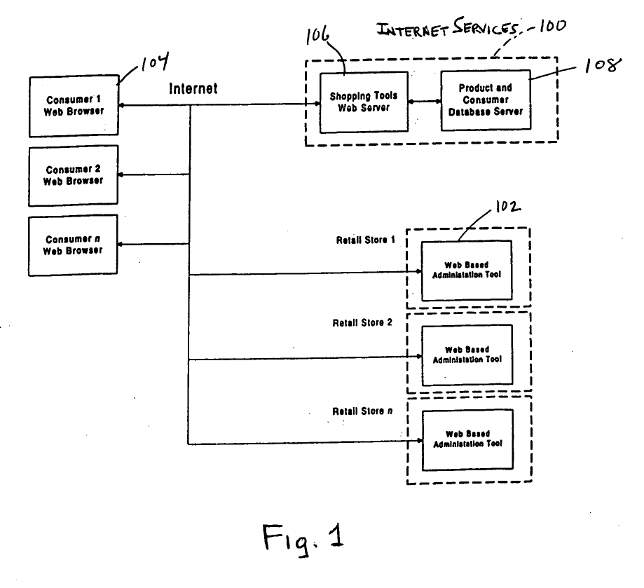

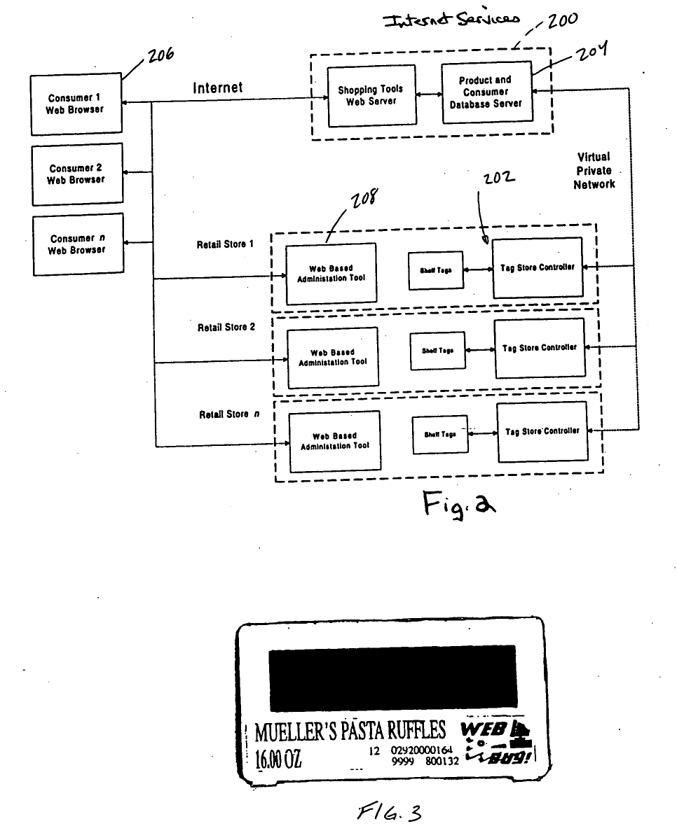

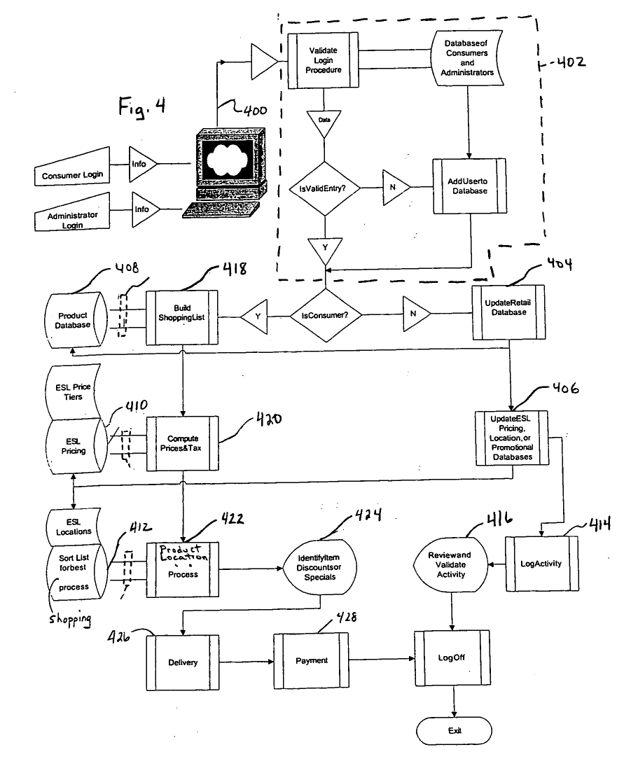

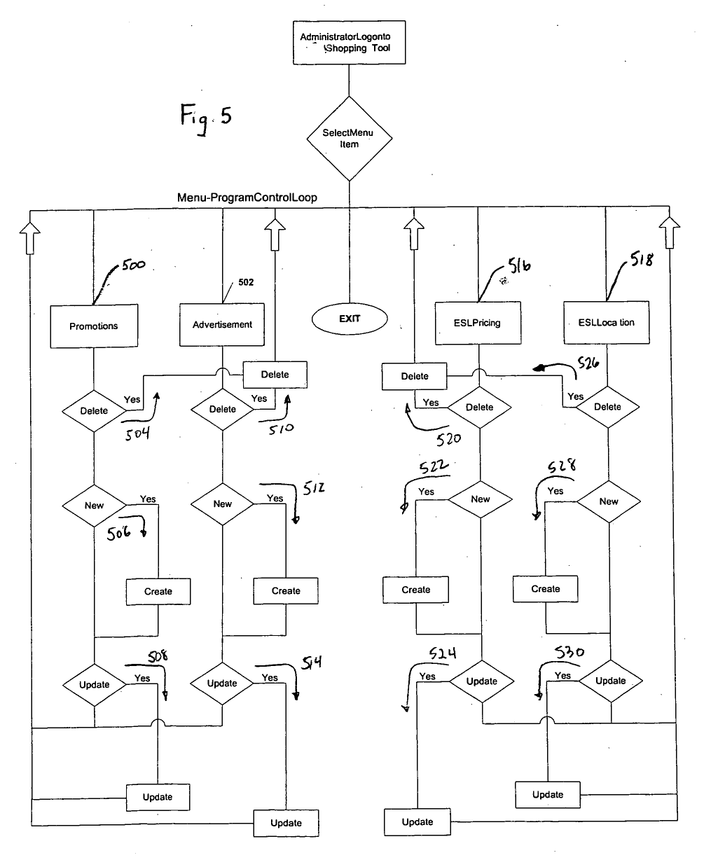

FIG. 4 provides an overview flow diagram of one embodiment of the system. In the illustration, the Internet is used as the communication link 400. The role of the user is determined during the login process. Users enter login information which is verified against stored information as shown at 402. New users may also be added to the system. Once logged in, consumer and retailers (administrator) are given options that differ.

The retailer is permitted to modify product description, prices, location and marketing material, as indicated at 404 and 406, in the product databases 408 and pricing and location databases 410 and 412. The retailers activity may be logged for later evaluation/analysis at 414. At 416 the retailer may review the immediately preceding activity for verification and validation.

The consumer options enable a user to plan menus, create shopping lists and user profiles in addition to consumer inventory control, as previously mentioned. The software interlock mechanism 410 described above may be used to prevent a consumer from receiving pricing information from database 408, or other ESL derived databases 410 and 412, if a last communication between the ESL system 202 or retailer and the web services system 200, 100 exceeds a set time. The interlock reduces liabilities for a retailer who is subject to requirements that accurate, up to date information be conveyed to consumers.

The consumer can input a desired shopping list or a list of items to be checked for specials at 418. Where the consumer desires to see the total cost for the entered list such information may be computed at 420 and displayed for the consumer. Special pricing (such as promotions and/or tiered pricing) information may also be determined and displayed at 420. Where a consumer is interested in receiving a list of product locations, an appropriate product list ordered by product location in the store to facilitate fast and simple shopping may be established at 422 for display and/or printing by the consumer. Item discounts and specials may be identified at 424. In a wholly automated shopping embodiment, the generated product location list may be provided to the retailer for use in retrieving the products for delivery to the consumer. In this regard, the user may enter desired delivery information at 426 and may make advance payment for the products via an electronic transaction (such as credit card) at 428.

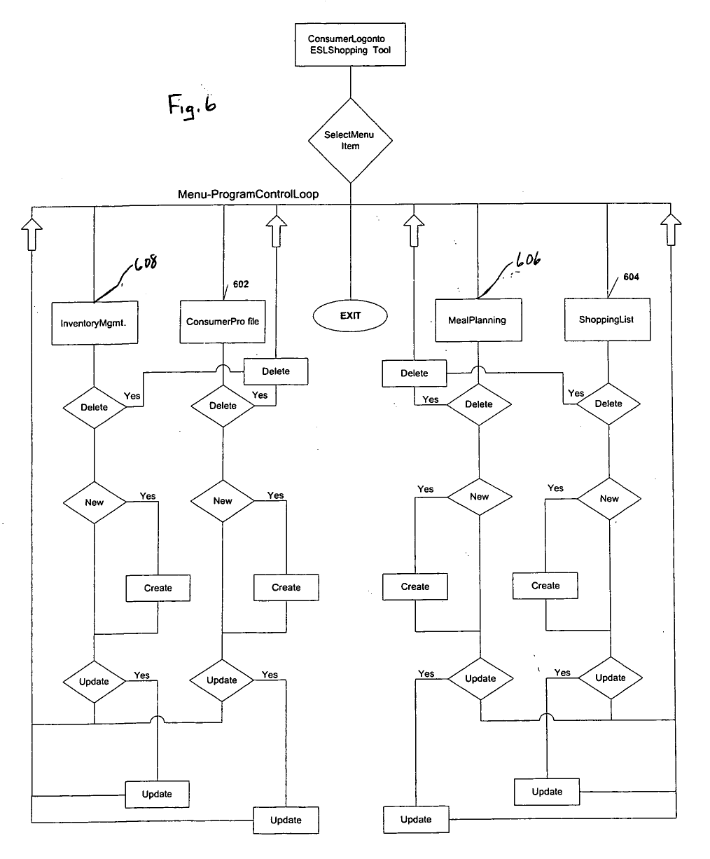

A user could access the system of invention over the Internet, using a personal computer, telephone, cell phone or any communication medium or device that affords access to the network. The standard login process may determine the role of the user. FIG. 5 provides a view of the administrator role and how a retailer uses the tool. A retailer's primary focus is typically to increase sales and reduce cost. The shopping tool enables a retailer to create, update and delete store promotions 500 and advertisements 502 that will be transmitted to consumers when they are using the shopping tool. The respective process paths for promotions and advertisements are shown at 504 and 510 (delete), 506 and 512 (create), and 508 and 514 (update). The content of these promotions and advertisements is determined by the relationship between the retailer and the consumer. For instance, a frequent shopper might be given a tiered price.

The web services system may contain a consumer profile database as entered by the consumer at 602 (FIG. 6) that the retailer uses to identify these consumers. The retailer may also use the tool to remotely monitor and adjust product information such as pricing 516 or product location 518 using similar paths 520 and 526 (delete), 522 and 528 (create), and 524 and 530 (update).

FIG. 6 provides a view of the consumer role. They have the option to create, update or delete the consumer profile 602, shopping list 604, meal planner 606 or product inventory 608 list, again using delete, create and update paths. Software algorithm may enable a consumer to plan purchases using the information from the inventory and the shopping list.

The web services system 200, when used with a store equipped with an ESL system 202, may provide a special annunciator such as a light emitting device located on multiple display tags/modules to alert the consumer of special pricing. The ESL system 202 may include a database of stored tag records which includes a flag which controls the annunciator of the respective tag. In the ESL system 202 the flag may identify tags associated with products on sale or identify tags associated with products included in the tiered pricing scheme. The state of this same flag may be used by the web services system 200 when uploaded thereto to identify products which are on sale, special or some other promotion. Other flags may be included in the ESL system databases (which are uploaded to the web services system) to identify tags which need new labels, tags which need an associated shelf talker, or tags which need maintenance. In the store, electronic tags associated with products on special may incorporate a web directing label thereon (FIG. 3) which can be used to direct store customers to the consumer shopping web site.

Further, the electronic display module or tag may show the consumer that a tiered pricing scheme such as a customer loyalty program is in effect for a specific product. That is, the ESL system 202—which stores product information for each display tag/module—may include a stored pricing tier for each product, with customers qualifying for certain prices based upon frequency or amount of purchase or some other basis. When a user submits a frequent shopper password or I.D. and a desired product list to the web services system 200, the web services system may identify those items which are on a tiered pricing schedule and provide the user with their price tier for the product(s), which the customer may print. In this configuration, the display module or tag in the store may not reveal all price tiers. Instead, the price tier information may be communicated to the web services system 200 requiring the consumer to visit the web site to learn their unique pricing on the highlighted product. The consumer may print out a list of its preferred prices. Alternatively, the special pricing might be revealed to the consumer using direct mailing, direct e-mailing, in store flyers, display boards, or in-store information kiosks.

The shopping tool provides a feature that allows the consumer to enter and maintain a stored list of desired products per 418, 604 mentioned above. This feature will let the consumer scroll through a categorized product database and select items to be added to their list. When stored, the list may be associated with the user's login information for later retrieval by the user. Alternatively, the consumer may use a small personal bar code scanner to capture and add items to the list. In addition, the web services system 200 may be operable to access a users profile information as well as historical purchase information (as tracked by the ESL system 202 or associated point of sale system in the store) 412 and seasonal information to make recommendations for this list. Once completed, the list of desired products may be processed through a store database which includes item location information. The information provided from the ESL system 202 can allow the list to be sorted in the order of product location within the store, to assist the user during shopping as previously mentioned. Alternatively, retail stores that do not have an ESL system 202 can supply the product location information to the system manually (FIG. 1). The resulting sorted list can be printed by the consumer when logged in to the web services system 100, 200 or accessed at a kiosk located within the store.

A Pantry Inventory Manager feature may also be included on the web services shopping tool. This feature allows the consumer to enter and maintain a list of items that are available in the user's kitchen as well as track items that are depleted. A simple on screen editing feature can be used to update this inventory. Periodically, the pantry inventory can be processed to generate a list of product recommendations according to those products which have been depleted or most often used. The items on this list can be automatically added to the user's shopping list of desired products.

A Menu Manager feature which may be provided with the web services shopping tool provides a calendar for household meal planning. A database of preferred recipes may be provided for the consumer to browse and select. Where a database of the contents of the pantry is maintained as noted above, this menu manager feature can generate menu suggestions that require available items from the user's pantry by comparing the ingredients required for the preferred recipes with the items stored in the user's pantry inventory database. If a recipe is selected that requires an unavailable ingredient, that item can be automatically added to the user's shopping list of desired products.

The web services system 100, 200 may provide information to the consumer that changes on a daily basis. The user can select the store or stores that they wish to shop. The consumers may be given the option to enter specific information about themselves. This information can include location, size of family, number of pets, display options, preferred stores as well as customer loyalty program information. This customer specific information can be used to allow more personalized promotions and pricing tiers. Alternatively, the consumer can choose to remain anonymous by entering the zip code for the area of interest. The user can then select local stores, submit a list of desired products, and receive a list of store specials, a shopping list price or total comparison and special promotional offers. Retailers will have an opportunity to compete through product specials and services while manufacturers can affect changes to the list of desired products through product promotions and target coupons. When the user submits a list of desired products the web services system 100, 200 can return a total price for multiple stores allowing the user to determine a preferred store at which to shop. Alternatively, upon submission of the desired products list the web services system 100, 200 may return a list identifying the number of list items which are on sale at each store.

Target coupons and promotions provide the manufacturers with a unique marketing tool. Alternative product suggestions can be given to the consumer in response to the items on their list of desired products. For those manufacturers that participate, discount databases will be compared to the list of desired products and a target coupon will be dispensed when a competitive product is identified. The coupon may be automatically displayed on the screen, e-mailed to the consumer or distributed within the store. These target coupons represent a very efficient method of coupon dispensing to those customers that are likely to use a manufacturer's product.

To further describe the drawings, FIG. 1 shows the distribution of various pieces of hardware and software that make up the first embodiment. This embodiment includes the web server 106 and database server 108 which facilitate the shopping and administration tools. FIG. 2 shows the distribution of various pieces of hardware and software that make up the second embodiment. This embodiment adds the electronic shelf label system 202 and associated shelf tag modules along with a secure Virtual Private Network (VPN) link to the web services system 200. The embodiment of FIG. 2 provides the features detailed above by using data that is continuously or periodically collected though the secure Virtual Private Networking link to the ESL System 202 at each retail store and the web based administration tools. Information about product availability, pricing, location, and specials may be automatically updated to the web services system 200 and its databases. Customer loyalty account information may also be passed through the service between the consumer and the store. Finally, a list of desired product information, activated specials, dispensed coupons, and other store notification information such as ordering pre-packaged goods for pick-up can be transmitted back to the store using the secure virtual private network. A similar link to store headquarter offices, remote administration or an order fulfillment site may be utilized. The VPN link might be a secure Internet link or a more direct, dedicated link.

While the invention is susceptible to various modifications and alternative forms, specific embodiments thereof have been shown by way of example in the block diagram and will be described in detail herein. It should be understood, however, that it is not intended to limit the invention to the particular forms disclosed, but, on the contrary, the intention is to cover all modifications, equivalents, and alternatives falling within the scope of the invention defined by the appended claims.

1-4. (Canceled).

5. A computerized consumer shopping tool, comprising
an Internet web services system,
at least one ESL computer system linked to the Internet web services system for communication therewith,
the Internet web services system including at least one database of product information received from the ESL computer system;
wherein at least one of the ESL computer system and the Internet web services system is operable to trigger communication with the other system on a regular basis;
wherein the Internet web services system includes a software interlock for preventing the retrieval or display of at least certain information within at least one database if a time period since a last communication operation between the ESL computer system and the Internet web services system exceeds a set threshold.

6. A method of providing consumer access to store product and pricing data, the method comprising the steps of:
providing a web site system from which a consumer can access product and pricing information for a plurality of stores;
providing a communications link for communicating store product and pricing information from stores to the web site system;
monitoring a time since a last product and pricing information update from a given store; and
preventing the consumer from accessing the product and pricing information for the given store if the time exceeds a set threshold.

7. The method of claim 6 wherein the communications link is an automated link at least between an in-store computer system of the given store and the web site system, at least one of the in-store computer system and the web site system operable to initiate communication between the two systems.

8. The method of claim 6 wherein the communications link is a store user-controlled Internet link.

9. A computerized consumer shopping tool comprising:
an Internet Web Site including a web server operable to enable a given user to enter and store a list of desired products and information identifying desired stores, the web server operable to look up stored pricing information for the desired stores and list of desired products, the web server operable to provide the given user total cost information for the list of desired products for each desired store for comparison purposes.

10. The computerized shopping tool of claim 9 wherein product pricing data for the desired stores is made available to the web server from each given store from one of a linked electronic shelf edge display system of the given store or a standard store price file stored on the web server.

11. The computerized shopping tool of claim 9 wherein the information identifying desired stores is entered by one of (i) selecting stores from a displayed list or (ii) entering location information.

12-18 (Canceled).
